(19) United States
(12) Patent Application Publication
(10) Pub. No.: US 2003/0200656 A1
(43) Pub. Date: Oct. 30, 2003

(54) Rocket assembly ablative materials, and method for insulating or thermally protecting a rocket assembly

(76) Inventor: Kenneth P Wilson, Corinne, UT (US)

Correspondence Address: JOSEPH A. WALKOWSKI, TRASKBRITT, PC, P.O. BOX 2550, SALT LAKE CITY, UT, 84110, US

(21) Appl. No.: 09/896,439

(22) Filed: Jun. 29, 2001

Related U.S. Application Data
(60) Provisional application No. 60/215,064, filed on Jun. 30, 2000.

(51) Int. Cl. F02K 1/00

(52) U.S. Cl. 29/890.01; 156/62.2; 156/212; 264/29.1; 60/200.1

(57) ABSTRACT

A rocket motor ablative material (e.g., an insulation liner, bulk material, or the like) of this invention is formed from, as a precursor of the carbon reinforcement structure, one or more polyarylamides configured as a suitable reinforcing structure, such as a yarn, flock, and/or felt. Aramid yarns can be prepared by twisting/spinning aramid filaments, and/or by carding and yarn-spinning staple aramid fibers. In particular, the insulation may be used, for example, for a rocket motor nozzle or as a rocket motor heat shield subjected to conditions comparable to those of continuous filament viscose rayon.

### RELATED APPLICATION

The benefit of priority is claimed of U.S. provisional application 60/215,064 filed in the U.S. Patent & Trademark Office on Jun. 30, 2000, the complete disclosure of which is incorporated herein by reference.

### BACKGROUND OF THE INVENTION

1. Field of the Invention

This invention relates to rocket motor ablative materials, especially resin-filled carbon fiber and carbon/carbon ablative materials, and a method for making the ablative materials. In particular this invention relates to carbon ablative materials having a reinforcement component formed from, as a precursor prior to carbonization, an aramid material, especially a meta-aramid material. This invention also relates to rocket motor assemblies comprising the carbon ablative materials.

2. Description of the Related Art

It is generally accepted current industry practice to prepare insulation for solid rocket motors from a polymeric base composite importantly including a carbon cloth. The composite is generally composed of the carbon cloth as a woven reinforcement structure impregnated with a suitable resin matrix. The resin matrix is commonly a phenolic resin, although other resin matrices can be used. For making the woven reinforcement structure, current industry practice is to select a continuous filament non-solvent spun viscose rayon as a precursor material. The continuous filament viscose rayon, which is especially formulated for ablative applications, is woven, wound, or otherwise manipulated into its desired configuration and then carbonized to form a carbon structure exhibiting superior ablation characteristics and excellent physical properties and processability.

Continuous filament viscose rayon precursor has been established as a standard in the rocket motor industry for making carbon reinforced structures of carbon and carbon/carbon ablative materials due to its superb ablation characteristics, excellent physical and thermal properties, and high processability. One of the excellent physical properties possessed by composites formed from continuous filament viscose rayon precursor is a cured composite high warp strength of about 144.8 MPa (or about 21,000 lbs/in²) at ambient temperature (about 21° C. or 70° F.), as measured subsequent to carbonization and impregnation of the precursor. Warp strength reflects the tolerance of the filament to opposing forces acting along the warp (or longitudinal) filament axis.

However, a major drawback associated with the use of cured composites comprising wrapped layers of continuous filament viscose rayon, such as found within the bulk areas of much rocket nozzle insulation, involves the availability of this particular type of continuous filament. Over the past few years, the only manufacturer producing sufficient quantities of continuous filament viscose rayon to meet industry demands is North American Rayon Corp. (NARC) of Elizabethton, Tenn. The capability of the industry to produce ablative liners and other thermal insulation based on continuous filament viscose rayon has been compromised, however, due to the cessation of continuous filament viscose fiber production by NARC. There is therefore a need in this industry, previously not satisfied, to find an effective alternate source or a replacement candidate for the above-described standard thermal insulation formed from continuous filament viscose rayon precursor.

The requirements that a replacement candidate must satisfy in order to be acceptable and functionally effective are well known to be quite severe due to the extreme conditions to which the insulation is exposed. These conditions to which the insulation is exposed not only include exceedingly high temperatures but also severe ablative effects from the hot particles (as well as gases) that traverse and exit the rocket motor interior, or over the outer surface of re-entry vehicle insulators. The insulation must be able to withstand such conditions.

Accordingly, any replacement insulation should exhibit comparable temperature resistant and ablation characteristics and rheological and physical properties at least equivalent to those of continuous rayon viscose filament, yet should not otherwise significantly alter the manufacturing process employed for the production of the thermal insulation. Additionally, due to the large and growing quantities of solid propellant rocket motor insulation required by the industry, any such replacement reinforcement precursor candidate should be abundantly available now and into the foreseeable future.

One alternative carbon precursor that has been proposed for ablative applications is continuous filament polyacrylonitrile (PAN). PAN continuous filaments disadvantageously possess higher densities than cellulosic materials (1.8 g/cm³ for PAN, compared to 1.48 g/cm³ for cellulosic filaments) and higher thermal conductivities than cellulosic materials. Thus, in order to provide a comparable insulation performance to rayon filaments, rocket motor nozzle insulation or re-entry vehicle insulation formed from PAN filament must have a greater thickness and weight than a comparable-performing insulation formed from cellulosic materials. The replacement material must meet the ablation limits for protection of the casing (when used as an internal casing insulation) throughout the propellant burn without adding undue weight to the motor.

Another alternative carbon precursor is discussed in PCT/US99/18721, which describes an ablative material (e.g., an insulation liner or the like) formed from, as a precursor of a carbon reinforcement structure, yarn comprising carded and yarn-spun cellulosic (e.g., rayon) fibers. The staple cellulosic fibers are processed, such as by spinning, into yarns which, upon patterning (e.g., weaving in any weave style or winding) and subsequent carbonization, serve as a reinforcement. Similarly, PCT/US99/18722 further discloses that a rocket motor ablative material can be formed from, as a precursor of the carbon reinforcement structure, yarn comprising either carded and yarn-spun solvent-spun cellulosic (e.g., rayon) fibers or solvent-spun cellulosic filaments. Ablatives made from such rayon precursors possess excellent mechanical strength for rocket motor applications, yet do not release unacceptable levels of fiber fly—i.e., short, waste fibers—into the air in textile processing operations such as carding, yarn-spinning, and weaving.

Although staple rayon production is widespread and sufficiently available to those skilled in the art to obviate any obsolescence issues, rayon is relatively time-consuming to produce and expensive due to its low production yields and intensive processing conditions.

Accordingly, the search for a functionally satisfactory precursor for making the reinforcement structure of a composite material requires discovery and implementation of an extraordinarily complex combination of performance and processing characteristics. Thus, one of the most difficult tasks in the solid propellant rocket motor industry is the development of a suitable, acceptable insulation that will meet and pass a large number of test and processing criteria to lead to its acceptability, yet is relatively inexpensive compared to staple rayon.

### SUMMARY OF THE INVENTION

It is, therefore, an object of this invention to address a crucial need in the industry to reformulate the ablative liners and thermal liners of rocket motors by finding a suitable, inexpensive replacement precursor for making carbon-based reinforcement structures. As referred to above, suitable replacement means a precursor material that can be substituted for continuous filament viscose rayon without requiring significant amounts of modification to the impregnating resin composition, component design, and manufacturing process steps. Also, when carbonized and impregnated with a suitable resin, the resulting ablative preferably possesses suitable properties, in particular overall strength, to function in high temperature environments that a rocket motor is exposed to.

In accordance with the principles of this invention, these and other objects of the invention are attained by the provision of a rocket motor ablative material (e.g., an insulation liner, bulk material, or the like) formed from, as a precursor of the carbon reinforcement structure, one or more polyarylamides (also referred to herein as aramids or aramides) configured as a suitable reinforcing structure, such as a yarn, flock, and/or felt. Aramid yarns can be prepared by twisting/spinning aramid filaments, and/or by carding and yarn-spinning staple aramid fibers. The inventor discovered that aramids are capable of being processed and subsequently carbonized into a prepreg reinforcement that, in combination with a suitable resin matrix, can function as insulation. In particular, the insulation may be used, for example, for a rocket motor nozzle or as a rocket motor heat shield subjected to conditions comparable to those of continuous filament viscose rayon.

This invention is also directed to a rocket motor assembly comprising ablative materials comprising reinforcing structures formed from, as a precursor prior to carbonization, aramids. This invention is further directed to a process for making a rocket motor assembly comprising the ablative materials, including nozzle and re-entry vehicle components.

Other objects, aspects and advantages of the invention will be apparent to those skilled in the art upon reading the specification and appended claims which, when taken in conjunction with the accompanying drawings, explain the principles of this invention.

### BRIEF DESCRIPTION OF THE DRAWINGS

The accompanying drawings serve to elucidate the principles of this invention. In such drawings:

FIG. 1 is a schematic cross-sectional view depicting the insulation of this invention interposed between a rocket motor casing and solid propellant;

FIG. 1A is an enlarged view of the insulation of FIG. 1; and

FIG. 2 is a perspective sectional view identifying some of the regions of a rocket motor nozzle assembly in which the insulation of this invention may be applied.

### DETAILED DESCRIPTION OF THE INVENTION

It is presently envisioned to select a poly(meta-arylaramid), and more preferably poly(m-phenyleneisophthalamide), which is commercially available as NOMEX®, as the aromatic polyamide of choice, although this invention may encompass other aromatic polyamides alone or in combination with NOMEX®. The aromatic polyamide may also be combined with other suitable precursor materials, such as cellulosic rayon. NOMEX® is commercially available from DuPont, and has the following structure

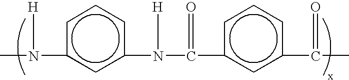

According to a first embodiment of this invention, the replacement precursor material for preparing carbon reinforcement structures of rocket motor ablative materials comprises bundled aramid filaments, especially aramid filaments twisted/spun into a yarn. The yarn preferably has an average denier per fiber (dpf) in a range of from 1.5 dpf to 3.0 dpf, such as 2.0 dpf.

In accordance with a second embodiment of the invention, the replacement precursor material for preparing carbon reinforcement structures of rocket motor ablative materials comprises carded and yarn-spun aramid staple fibers. As referred to herein and understood in the art, carded means staple fibers subjected to a process or passed through a machine designed to promote the at least partial separation and at least partial alignment of the staple fibers. Carding encompasses techniques used in the production of both fine and coarse yarns. As referred to herein and understood in the art, yarn-spun means a yarn formed by a combination of drawing or drafting and twisting of prepared staple fibers. Spinning (or yarn-spinning) of carded staple fibers as referred to in the context of this second embodiment is not intended to mean techniques consisting of the extrusion of continuous filaments, which techniques can be performed during solvent-spinning. As referred to herein, staple fibers are fibers having lengths suitable for yarn-spinning.

In the case of aramid staple fibers, the staple fibers preferably have average fiber lengths in a range of from 38 mm to 225 mm, such as 100 mm to 150 mm, and, when processed into a yarn, have an average denier per fiber (dpf) in a range of from 1.5 dpf to 3.0 dpf, such as 2.0 dpf.

The filaments of the first embodiment and staple fibers of the second embodiment of this invention are preferably untreated, meaning that they are free of any distinct metallic, metalloidic, or graphitic coating, at least prior to (and preferably subsequent to) graphitization.

One of the advantageous features of this invention is that the yarn comprising either the aramid filaments or the carded and spun aramid staple fibers may be substituted for conventional continuous filament viscose rayon without significantly altering the ablative material manufacturing process. The only substantial alteration from the conventional continuous filament viscose rayon manufacturing process resides in the carding and yarn-spinning of the staple fibers for the second embodiment. Generally, continuous filament viscose rayon is produced by dissolving cellulose into a viscose spinning solution, and extruding the solution into a coagulating medium where the polymer is cellulose and is regenerated as a continuous filament. On the other hand, the yarn used in the second embodiment of the present invention is prepared from staple fibers, which are carded and spun by techniques well known in the industry into a tight, compact yarn. It is understood that other processing techniques may also be used, such as combing and other steps well known and practiced in the art. Preferably, the spinning step is performed by either a worsted process or cotton-ring spinning process. The spinning process is advantageous to keep yarn hairiness to a minimum.

By way of example, the yarn produced by the first and second embodiments of this invention may have a weight comparable to the weight of standard yarns presently used for carbon ablative materials, i.e., about 1200-2400 denier. This may be accomplished with staple fibers by producing a yarn that is approximately 4.8 English worsted count (Nw), and two-plying the yarn to obtain the 1200 to 2400 denier configuration, preferably 1600 denier with 800 fibers per yarn. Determination of suitable amounts of twisting is within the purview of those skilled in the art.

The yarns are then subject to one or more patterning techniques, including, by way of example, weaving, winding, and plying, into a desired structure. Alternatively, the precursor materials may be subject to a non-woven process to thereby form, for example, a felt or flock structure. By way of example, the yarn may be woven in a 5 harness satin pattern to provide a fabric width of 152 cm and an area weight of 542 g/m². In this regard, the structuring of the yarns into the desired configurations can be performed in the same manner as that for conventional continuous filament viscose rayon.

The woven or non-woven structure is then carbonized to form the reinforcement of the ablative material. Carbonization can take place, by way of example and without limitation, at temperatures of at least 750° C. to 2800° C., such as 1250° C. or higher. The time/temperature schedule should be selected based on thermal degradation properties of the aramid. Thermographic gravimetric analysis (TGA) can be used to determine scheduling. It is preferable to purge the carbonization chamber with an inert gas, such as argon or nitrogen, which either can be flowed through the chamber or sealed within the purged chamber. Unlike carbonization of conventional PAN fibers, which require oxidative stabilization of the PAN fibers to prevent the PAN fibers from melting, oxidizing agents are unwanted in the carbonization of aramid precursors. This difference greatly reduces the processing time and production expense associated with the preparation of reinforcement based on aramid precursors compared to PAN precursors.

The carbonized reinforcement structure is then impregnated with an acceptable resin, such as a phenolic resin. A representative phenolic resin is SC1008, available from Borden Chemical of Louisville, Ky.

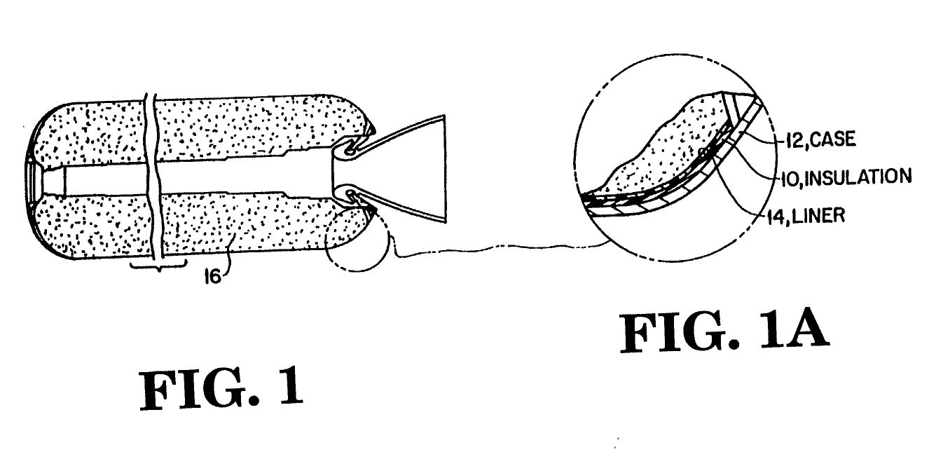

The inventive ablative and insulation materials can be applied to various parts of a rocket assembly, preferably as multi-layered structures. Depending on its intended use, the impregnating resin can be either carbonized or not subject to carbonization, prior to application to the rocket motor assembly. For example, the ablative and insulation materials can be used as a chamber internal insulation liner, as shown in FIGS. 1 and 1A. Referring to FIG. 1, the insulation 10, when in a cured state, is disposed on the interior surface of the rocket motor case 12. Typically, a liner 14 is interposed between the insulation 10 and the propellant 16. The insulation 10 and liner 14 serve to protect the case from the extreme conditions produced by the burning propellant 16. Methods for loading a rocket motor case 12 with an insulation 10, liner 14, and propellant 16 are known to those skilled in the art, and can be readily adapted within the skill of the art without undue experimentation to incorporate the insulation of this invention. Liner compositions and methods for applying liners into a rocket motor case are also well known in the art, as exemplified by U.S. Pat. No. 5,767,221, the complete disclosure of which is incorporated herein by reference. Although FIG. 1 shows a solid propellant grain, the ablative materials of this material can be used with other propellant formulations, including hybrid and bi-liquid propellants.

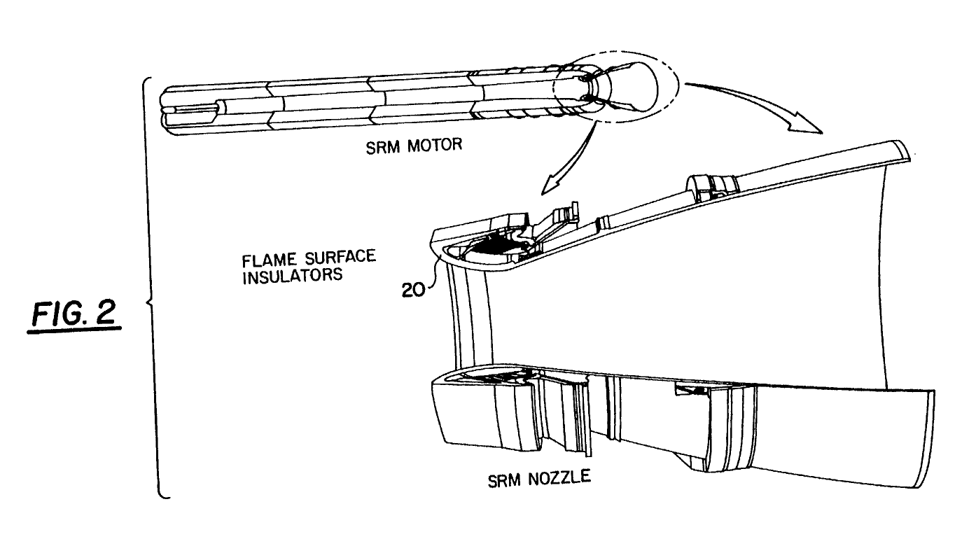

The ablative and insulation materials can also (or alternatively) be applied along the flow path of the nozzle structure through which the combustion products pass, such as shown by the shaded area 20 of the exit nozzle shown in FIG. 2. The ablative materials can be exposed along the flow path, and/or can be covered by suitable materials, such as refractory metals.

### EXAMPLE

The following example illustrates an embodiment that has been made in accordance with the present invention. Also set forth is a comparative example prepared for comparison purposes. The inventive embodiments are not exhaustive or exclusive, but merely representative of the invention.

| | Meta-Aramid | Filament Rayon |
|---|---|---|
| Yarn Properties | | |
| Yarn Denier (g/9 kM) | 1600 | 1650 |
| Fibers per yarn | 800 | 720 |
| Denier per filament (dpf) | 2.0 | 2.3 |
| Woven Fabric Properties | | |
| Fabric Width (cm) | 152 | 152 |
| Area Weight (g/m²) | 542 | 576 |
| Weave pattern | 5 harness satin | 8 harness satin |
| Carbon Fabric Properties | | |
| Fabric Width (cm) | 111 | 109 |
| Area Weight (g/m²) | 327 | 271 |
| Carbon Content (%) | 95.6 | 97.7 |
| Carbon Yield (%) | 48 | 22 |
| Prepreg Properties | | |
| Carbon Content (%) | 48.7 | 50.6 |
| Resin Content (%) | 35.5 | 34.2 |
| Filler Content (%) | 15.8 | 15.2 |
| Ablative Properties | | |
| Nozzle Erosion Rate (μm/s) | 155 | 171 |
| Char Depth (mm) | 9.4 | 8.2 |
| Total Heat Effect Depth (mm) | 14.7 | 14.2 |

Testing was based upon solid fuel rocket motor test firing of 35 seconds at 6.2 Mpa (900 psi). As seen from the table, the ablative material made from the meta-aramid fiber exhibited comparable, if not superior, properties to those of an ablative material made of filament rayon.

The foregoing detailed description of the invention has been provided for the purposes of illustration and description. It is not intended to be exhaustive or exclusive in its description of the precise embodiments disclosed. The embodiments were chosen and described in order to best explain the principles of the invention and its practical application, thereby enabling others skilled in the art to understand the invention for various embodiments and with various modifications covered within the spirit and scope of the appended claims.

What is claimed is:

1. A method for insulating or thermally protecting a rocket motor assembly comprising a rocket motor casing, a propellant, and a nozzle assembly, said process comprising (a) forming a rocket motor ablative material from a prepreg comprising at least one impregnating resin matrix and a reinforcement comprising, as a precursor prior to carbonization, at least one aromatic polyamide and (b) insulating or lining a portion of the rocket motor assembly with the rocket motor ablative material.

2. The method of claim 1, wherein the reinforcement comprises carded and yarn-spun staple aramid fibers.

3. The method of claim 1, wherein the reinforcement comprises yarn-spun aramid filaments.

4. The method of claim 1, wherein the reinforcement comprises at least one member selected from the group consisting of aramid felt and aramid flock.

5. The method of claim 1, wherein said insulating or lining of a portion of the rocket motor assembly comprises applying the ablative material as a bulk ablative material of an exit nozzle liner.

6. The method of claim 1, wherein said insulating or lining of a portion of the rocket motor assembly comprises applying the ablative material as a bulk ablative material of a reentry vehicle nose cone.

7. A method for insulating or thermally protecting a rocket motor assembly comprising a rocket motor casing, a propellant, and a nozzle assembly, said process comprising (a) forming a rocket motor ablative material from a prepreg comprising at least one impregnating resin matrix and a reinforcement comprising, as a precursor prior to carbonization, at least one poly(meta-arylaramid) and (b) insulating or lining a portion of the rocket motor assembly with the rocket motor ablative material.

8. The method of claim 7, wherein the reinforcement comprises carded and yarn-spun staple aramid fibers.

9. The method of claim 7, wherein the reinforcement comprises yarn-spun aramid filaments.

10. The method of claim 7, wherein the reinforcement comprises at least one member selected from the group consisting of aramid felt and aramid flock.

11. The method of claim 7, wherein said insulating or lining of a portion of the rocket motor assembly comprises applying the ablative material as a bulk ablative material of an exit nozzle liner.

12. The method of claim 7, wherein said insulating or lining of a portion of the rocket motor assembly comprises applying the ablative material as a bulk ablative material of a reentry vehicle nose cone.
